(19) United States
(12) Patent Application Publication
(10) Pub. No.: US 2013/0071583 A1
(43) Pub. Date: Mar. 21, 2013

(54) Auxetic Material

(71) Applicants: Kenneth Ernest Evans, Exeter (GB); Michael Robert Sloan, Exeter (GB); Julian Roger Wright, Totens (GB); Michael Kenneth Burns, Tiverton (GB)

(72) Inventors: Kenneth Ernest Evans, Exeter (GB); Michael Robert Sloan, Exeter (GB); Julian Roger Wright, Totens (GB); Michael Kenneth Burns, Tiverton (GB)

(21) Appl. No.: 13/378,296

(22) PCT Filed: Jun. 16, 2010
(86) PCT No.: PCT/GB2010/001166

§ 371 Date: Feb. 15, 2012

(30) Foreign Application Priority Data
Jun. 19, 2009 (GB) 0910621.2
Jul. 10, 2009 (GB) 0911985.0

(51) Int. Cl. B32B 1/06; D01F 8/00; B32B 1/08

(52) U.S. Cl. 428/34.1

(57) ABSTRACT

An auxetic material comprises an outer component of a relatively compliant material, and an inner component of a relatively stiff material, wherein the inner component is located within a cavity provided within the outer component, the cavity being of non-linear form in the longitudinal direction of the material when the material is at rest.

### CROSS REFERENCE TO RELATED APPLICATION

This application is the United States national stage filing of PCT/GB2010/001166 entitled “Auxetic Material” and filed Jun. 16, 2010. The aforementioned application claims priority to UK Pat. App. No. 0910621.2 filed Jun. 19, 2009, and UK Pat. App. No. 0911985.0 filed Jul. 10, 2009. Each of the aforementioned applications is incorporated herein by reference for all purposes.

### BACKGROUND OF THE INVENTION

The present invention relates to an auxetic material, and in particular to auxetic fibres or yarns.

Auxetic fibres or yarns are materials which possess the property that under the application of a tensile load thereto, the fibres or yarns expand in a direction perpendicular, or transverse, to the direction in which the load is applied.

One form of auxetic fibre is described in WO2007/125352 and comprises an inner component around which an outer component is wound. The inner component is of lower modulus of elasticity than the outer component, and the intertwining of the components is such that the application of a tensile load to the fibre to stretch the fibre in its longitudinal direction forces the outer, less elastic, component to become straighter which, in turn, forces the inner, more elastic, component to take on a helical-like configuration. As a result, the overall thickness or diameter of the fibre is increased. In other words, the fibre has expanded in the transverse direction.

It is known to use fibres or yarns of this general type in the formation of textile fabrics for certain uses. However, the presence of the outer component wound around the inner component has resulted in problems being faced in handling of the fibre or yarn and in the manufacture of textile fabrics incorporating the fibre or yarn as there is a tendency for the outer component to become trapped or tangled as the fibre or yarn passes through parts of the manufacturing equipment. As a result, the manufacturing equipment may need to be stopped, resulting in manufacturing inefficiencies, and/or in the production of unacceptable quantities of substandard fabric. Further, some parts of the outer component may slip along the inner component with the result that the winding of the outer component is non-uniform.

Hence, for at least the aforementioned reasons, there exists a need in the art for advanced fibres.

### BRIEF SUMMARY OF THE INVENTION

The present invention relates to an auxetic material, and in particular to auxetic fibres or yarns.

Various embodiments of the present invention provide auxetic materials that include an outer component and an inner component. The outer component is of a relatively compliant material, and the inner component is of relatively stiff material. The inner component is located within a cavity provided within the outer component, the cavity being of non-linear form in the longitudinal direction of the material when the material is at rest. In some instances of the aforementioned embodiments, the cavity is of generally helical form, the inner component likewise being of generally helical form. In one or more instances of the aforementioned embodiments, the cavity is of wave-like form. In some instances of the aforementioned embodiments, the outer component is of generally cylindrical shape. In various embodiments of the present invention, the inner component is of substantially uniform pitch. In some embodiments of the present invention, the inner component is of non-uniform or graded pitch.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a diagrammatic representation of a known type of auxetic material in a relaxed state;

FIG. 2 is a view similar to FIG. 1 illustrating the material when a tensile load is applied thereto;

FIG. 3 is a diagrammatic perspective view of a length of an auxetic material in accordance with an embodiment of the invention;

FIGS. 4 and 5 are views similar to FIGS. 1 and 2 illustrating the auxetic material of FIG. 3 in a relaxed state and in a state where a tensile loading is applied thereto;

FIG. 6 illustrates a modification; and

FIG. 7 is a photograph illustrating some of the disadvantages of known materials.

### DETAILED DESCRIPTION OF THE INVENTION

The present invention relates to an auxetic material, and in particular to auxetic fibres or yarns.

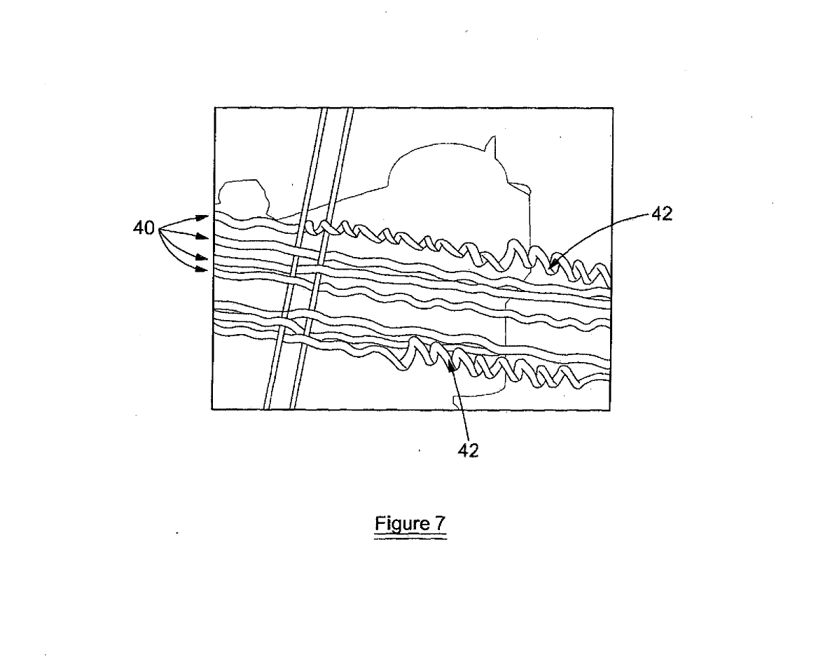

FIG. 7 is a photograph illustrating a condition where the outer component has slipped along the inner component resulting in the winding of the outer component being non-uniform, the arrangement shown in FIG. 7 including a plurality of yarns 40 and, as shown at positions 42, some of the outer components thereof have become significantly displaced and bunched which would result in incorrect functioning of the yarn in subsequent use. This may negatively impact upon the performance of the fibre or yarn in that expansion thereof in the transverse direction when a tensile load is applied thereto may be irregular.

It is an object of some embodiments of the invention to provide an auxetic material in which at least some of the disadvantages outlined hereinbefore are overcome or are of reduced effect. According to one or more embodiments of the present invention, there is provided an auxetic material comprising an outer component of a relatively compliant material, and an inner component of a relatively stiff material, wherein the inner component is located within a cavity provided within the outer component, the cavity being of non-linear form in the longitudinal direction of the material when the material is at rest. In some cases, the auxetic material comprises an outer component of a relatively compliant material, and an inner component of a relatively stiff material, wherein the inner component is located within the outer component, the inner component being of non-linear form in the longitudinal direction of the material when the material is at rest. With such a material, the application of a tensile load thereto will urge the inner, stiffer or less elastic, component to become of increased straightness or linearity, the location of the inner component within the cavity forcing the cavity to become straighter, and hence forcing the outer, more compliant component to take on a non-linear form, thereby increasing its transverse dimension. It will be appreciated that one benefit of such a material is that the location of a wound, exposed outer component is avoided and so the disadvantages described hereinbefore resulting from the provision of an exposed component are overcome. IN particular cases, the cavity is of generally helical form, the inner component likewise being of generally helical form. As one example of an advantage of such an arrangement, the transverse expansion of the material upon the application of a longitudinal tensile loading thereto is relatively uniform. However, other arrangements are possible. For example, the cavity may be of wave-like form with the result that the transverse expansion of the material will not be uniform but rather occur, primarily, in one plane.

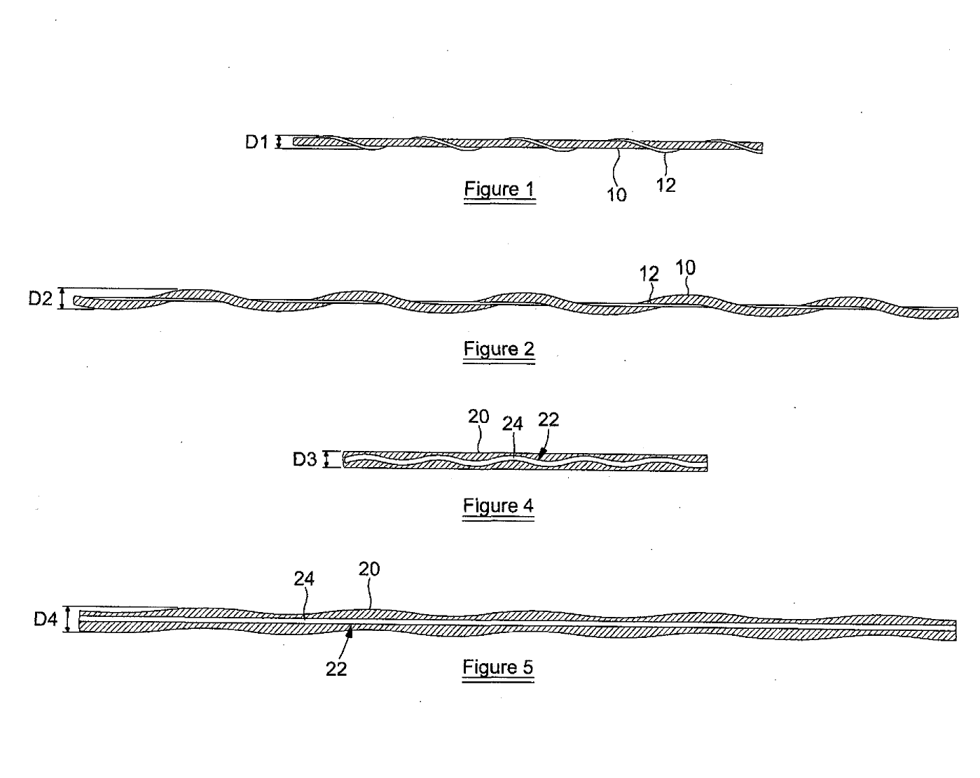

Referring firstly to FIGS. 1 and 2, a known type of auxetic material in the form of a fibre or yarn is shown. The material comprises an inner component 10 of a relatively compliant or low modulus of elasticity material such as a rubber or rubber-like material. The inner component 10, at rest, is of generally straight or linear form. Around the inner component 10 is wound an outer component 12 of a material which is relatively stiff or has a high modulus of elasticity material such as ultra-high molecular weight polyethylene (UHMWPE).

At rest, as shown in FIG. 1, the material is of relatively small overall transverse dimension, or overall diameter, D1. Upon the application of a tensile load to the material which forces the outer component 12 to be urged towards a more linear form as shown in FIG. 2, it will be appreciated that the inner component 10 effectively becomes wound about the outer component 12, and the overall transverse dimension, or diameter, of the material is significantly increased to dimension D2 as shown in FIG. 2.

Upon removal of the tensile load, the material will usually contract back to substantially the form shown in FIG. 1, the transverse dimension reverting back to substantially D1, unless the elastic limit of the inner component material has been exceeded.

Although reference is made hereinbefore to some specific materials for the inner and outer components, it will be appreciated that a number of other materials have been used. Further, although FIGS. 1 and 2 illustrate the material in two extreme conditions (relaxed and fully stretched), it will be appreciated that it can also occupy a number of intermediate conditions.

As outlined hereinbefore, such a material performs satisfactorily as an auxetic material but does suffer from the disadvantages that handling thereof is relatively complex as there is the risk of the outer component 12 becoming tangled or trapped, or becoming non-uniformly wound around the inner component 10.

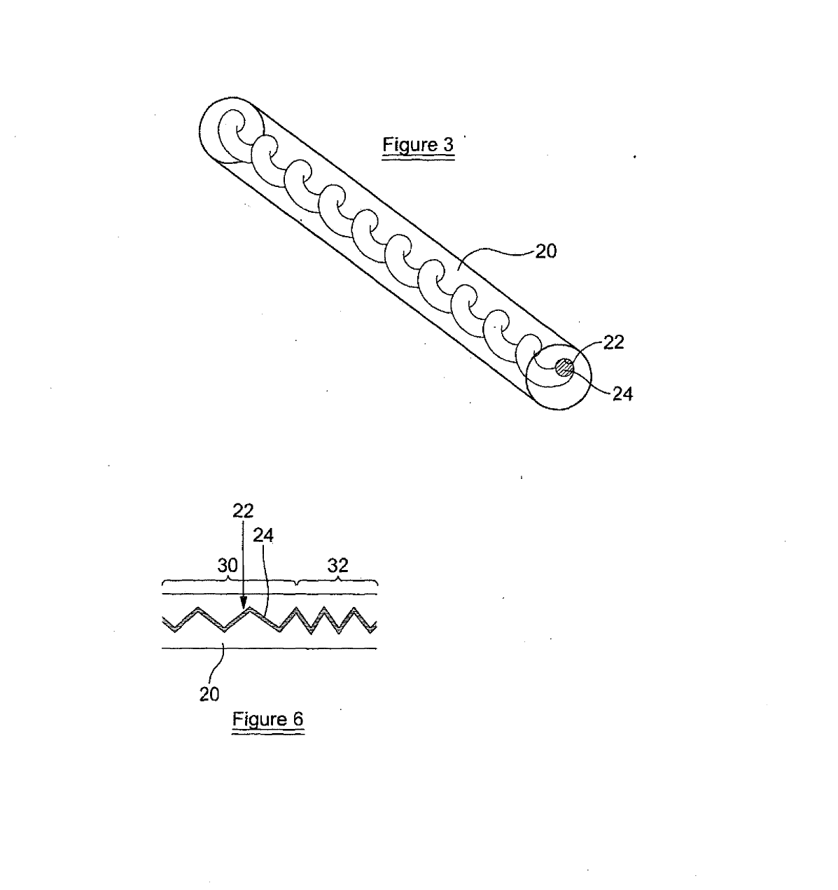

Referring next to FIGS. 3 to 5 there is illustrated, diagrammatically, an auxetic material in accordance with one embodiment of the invention. The auxetic material shown in FIGS. 3 to 5 comprises an outer component 20 of a relatively compliant material, for example a rubber or rubber-like material. The outer component 20 is, in this arrangement, of generally cylindrical form, but it will be appreciated that this need not always be the case. The outer component 20 defines an internal cavity 22 which, when the material is at rest, is of non-linear form. In this embodiment the cavity 22 is of generally helical form. The cavity 22 contains, and in this embodiment is substantially filled by, an inner component 24 of a relatively stiff material. As the inner component 24 is located within the cavity 22 which is of non-linear form, it will be appreciated that the inner component 24, likewise, is also of non-linear form when the material is at rest, and in this embodiment is of generally helical form.

As shown in FIG. 4, when the material is at rest, it has a transverse dimension or diameter D3. When a tensile load is applied to the material, stretching that material, the inner component 24 which is relatively stiff will tend not to stretch, but rather will become of more linear, or straighter, form than when at rest, and in the extreme will straighten out completely. As the inner component 24 is located within the cavity 22 of the outer component 20, the straightening of the inner component 24 forces the cavity 22 to also become of increased linearity which, in turn, results in the outer component 20 taking on a generally helical form as shown in FIG. 5. The overall transverse dimension, D4, of the auxetic material in this configuration is significantly larger than that, D3, when the material is at rest.

Upon removal of the applied load, the material will revert back to substantially the form shown in FIGS. 3 and 4 in which it is of diameter D3.

Although the arrangement described and illustrated herein has a generally helical cavity 22, and the inner component 24 is similarly shaped, it will be appreciated that this need not always be the case. For example, if desired the cavity 22 and inner component 24 could be of wave-like form rather than of three-dimensional helical form. As a result, the expansion of the material upon the application of a tensile load thereto will be less uniform than in the arrangement illustrated. It will be appreciated, however, that a number of other modifications and alterations are possible without departing from the scope of the invention.

In the arrangements described hereinbefore the cavity 22 is of substantially uniform pitch with the result that upon the application of a tensile load to the material, the expansion will be substantially uniform along the entire length thereof. There may be applications in which it is desirable for the material to expand more in some parts thereof and less in other parts thereof under some conditions. In the arrangement of the invention this may be achieved by arranging for the pitch of the cavity 22, and hence of the inner component 24 to be non-uniform along the length of the material. For example, as shown in FIG. 6, the material may include a region 30 in which the pitch of the cavity 22 and of the inner component 24 is relatively large, and a second region 32 in which the pitch is smaller. In such an arrangement, upon the application of a gradually increasing tensile load to the material, the region 30 will expand laterally first, ie at low loads/strains, and region 32 will expand laterally at a higher load. It will be appreciated that arrangements of this general type may take a wide range of forms. For example, the pitch may gradually increase and/or decrease along the length of the material, or may change in steps. Such functional grading of the material is not reliable, at least in a consistent fashion, in the prior materials as the slippage of the outer component along the inner component could far outweigh pitch changes introduced to achieve desired effects.

In the arrangements described hereinbefore, the outer component 20 is of a single material. However, arrangements may be possible in which a different compliant material is used radially inwards of the inner component 24 to that located radially outward of the inner component 24.

It will be appreciated that a number of materials are suitable for use as the inner and outer components, and that a number of different manufacturing techniques could be used in the formation or production of the material. For example, it is envisaged that the material may be manufactured using a coextrusion technique, using a revolving or rotating die component to achieve the formation of a helical or helical-like inner component 24. Alternatively, the inner component 24 may be extruded, and the outer component 20 subsequently molded around the inner component 24, although such a technique may only be suitable for use where the inner component 24 is able to support itself whilst the outer component 20 is molded. A further manufacturing method might involve at least three stages: the production of a cylindrical core, the application of a helical wrap 24, and the enclosure of these elements within a solid sheath, which may or may not consist of the same material as the core. Thus component 20 would be comprised of the former core and latter sheath. Such techniques have the advantage of being continuous. Batch-type processes, for example in which the outer component 20 is formed with a cavity into which the inner component is subsequently threaded or otherwise introduced may be possible, although will typically only be suitable for use in the manufacture of relatively short lengths of material. Another technique that is envisaged involves wrapping the inner component 24 onto the exterior of the outer component 20, and subsequently heating the material to soften the outer component 20 to such a degree that slight tensioning of the inner component will cause the inner component to sink into position within the slightly molten outer component which is subsequently cooled. It will be appreciated that a number of other manufacturing techniques are also possible.

It will be appreciated that in some of the manufacturing techniques mentioned above there is no explicit step of forming a cavity, but rather the outer component 20 is formed directly about or around the inner component 24 with the result that the inner component 24 entirely fills the ‘cavity’ and so no separate ‘cavity’ is discernable in the final product. The invention covers both the case where there is a discernable cavity, and where this is not the case.

In conclusion, the invention provides novel systems, apparatus, and methods for manufacturing such. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An auxetic material, the auxetic material comprising:
an outer component of a relatively compliant material; and
an inner component of a relatively stiff material, wherein the inner component is located within a cavity provided within the outer component, the cavity being of non-linear form in the longitudinal direction of the material when the material is at rest.

2. The material of claim 1, wherein the cavity is of generally helical form, the inner component likewise being of generally helical form.

3. The material of claim 1, wherein the cavity is of wave-like form.

4. The material of claim 1, wherein the outer component is of generally cylindrical shape.

5. The material of claim 1, wherein the inner component is of substantially uniform pitch.

6. The material of claim 1, wherein the inner component is of non-uniform or graded pitch.

7. An auxetic material, the auxetic material comprising:
an outer component of a relatively compliant material;
an inner component of a relatively stiff material, wherein the inner component is located within a cavity provided within the outer component; and
wherein the cavity within the outer component is of generally helical form.

8. The material of claim 7, wherein the outer component is of generally cylindrical shape.

9. The material of claim 7, wherein the inner component is of substantially uniform pitch.

10. The material of claim 7, wherein the inner component is of non-uniform or graded pitch.

11. An auxetic material, the auxetic material comprising:
an outer component of a relatively compliant material; and
an inner component of a relatively stiff material, wherein the inner component is located within a cavity provided within the outer component, the cavity being of non-linear form in the longitudinal direction of the material when the material is at rest, and wherein the cavity is of wave-like form.

12. The material of claim 11, wherein the outer component is of generally cylindrical shape.

13. The material of claim 11, wherein the inner component is of substantially uniform pitch.

14. The material of claim 11, wherein the inner component is of non-uniform or graded pitch.
